(19) United States
(12) Patent Application Publication
(10) Pub. No.: US 2005/0043180 A1
(43) Pub. Date: Feb. 24, 2005

(54) Optically active herbicidal (r)-phenoxypropionic acid-n-methyl-n-2-fluorophenyl amides

(76) Inventors: Dae Whang Kim, Daejeon (KR); Hae Sung Chang, Daejeon (KR); Young Kwan Ko, Daejeon (KR); Jae Wook Ryu, Daejeon (KR); Jae Chun Woo, Daejeon (KR); Dong Wan Koo, Daejeon (KR); Jin Seog Kim, Daejeon (KR); Bong-Jin Chung, Anyang (KR); Oh-Yeon Kwon, Suwon (KR)

Correspondence Address: MCNEES, WALLACE & NURICK LLC, 100 PINE STREET, P.O. BOX 1166, HARRISBURG, PA, 17108-1166, US

(21) Appl. No.: 10/494,084

(22) PCT Filed: Nov. 1, 2001
(86) PCT No.: PCT/KR01/01845

(51) Int. Cl. A01N 43/76

(52) U.S. Cl. 504/270

(57) ABSTRACT

The present invention relates to optically active herbicidal (R)-phenoxypropionic acid N-methyl-N-2-fluorophenyl amide compounds represented in the following formula (1), a method for preparing thereof, their use to prevent generation of barnyard grass produced from rice and composition as suitable herbicides, (I) wherein X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; is hydrogen or fluoro; and n is an integer of 0 to 2, wherein X can be a combination of other substituents when n is 2.

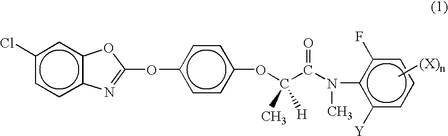

### TECHNICAL FIELD

The present invention relates to optically active herbicidal (R)-phenoxypropionic acid N-methyl-N-2-fluorophenyl amide compounds represented in the following formula (1), a method for preparing thereof, their use to prevent generation of barnyard grass produced from rice and composition as suitable herbicides, 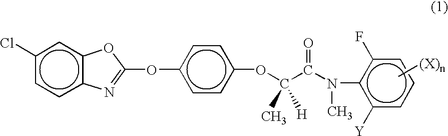
wherein X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;

Y is hydrogen or fluoro; and

n is an integer of 0 to 2, wherein X can be a combination of other substituents when n is 2.

### BACKGROUND ART

U.S. Pat. No. 4,130,413 discloses the compounds represented in the following formula (2), 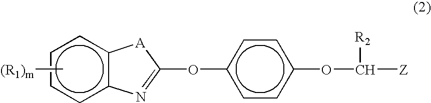
wherein (R₁)ₘ is hydrogen, halogen, CF₃, NO₂, CN or alkyl; A is O, S or NH; R₂ is hydrogen or alkyl; Z is 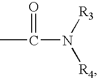
where R₃ and R₄ may be identical or different and represent hydrogen, C₁-C₆ alkyl, C₁-C₆ hydroxyalkyl, C₃-C₆ cycloalkyl, C₁-C₄ alkoxy, or phenyl substituted with 1 to 3 substituents chosen from C₁-C₄ alkyl C₁-C₆ alkoxy, halogen and CF₃.

U.S. Pat. No. 4,531,969 discloses the compounds represented in the following formula (3), 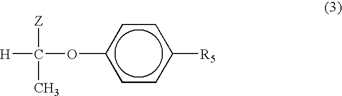
wherein R₅ is 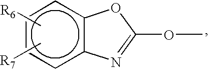
where R₆ is hydrogen or halogen; R₇ is hydrogen or alkyl; and Z is 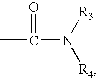
where R₃ and R₄ may be identical or different and represent hydrogen, C₁-C₆ alkyl, C₁-C₆ hydroxyalkyl, C₃-C₆ cycloalkyl, C₁-C₄ alkoxy, or phenyl substituted with 1 to 3 substituents chosen from C₁-C₄ alkyl, C₁-C₆ alkoxy, halogen and CF₃.

U.S. Pat. No. 5,254,527 discloses the compounds represented in the following formula (4), 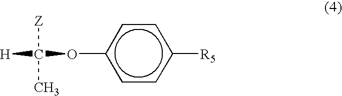
wherein R₅ is 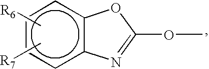
Z is 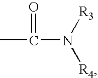
where R₃ and R₄ may be identical or different and represent hydrogen, C₁-C₆ alkyl, C₁-C₆ hydroxyalkyl, C₃-C₆ cycloalkyl, C₁-C₄ alkoxy, or phenyl substituted with 1 to 3 substituents chosen from C₁-C₄ alkyl, C₁-C₆ alkoxy, halogen and CF₃.

Even though some compounds of formula (1) of the present invention are disclosed in the above patents, none of the patents teach the synthesis of the compound of formula (1) and have tested the same for herbicidal activity.

JP Patent publication 2-11580 discloses the compound represented in the following formula (5), 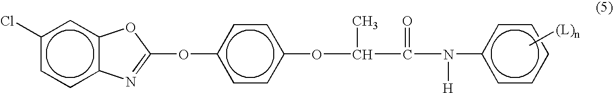
wherein L is low alkyl, halogen, methoxy, methoxyphenoxy, benzyloxy, methylthio or methylvinyl; and n is an integer of 0 to 2.

JP Patent publication sho 53-40767 and sho 54-112828 also disclose that phenoxypropionic acid amide derivatives have herbicidal activity.

Further, inventors of the present invention disclosed herbicidal phenoxypropionic acid N-alkyl-N-2-fluorophenyl amide compounds in International Pat. Publication No. WO 2000/05956.

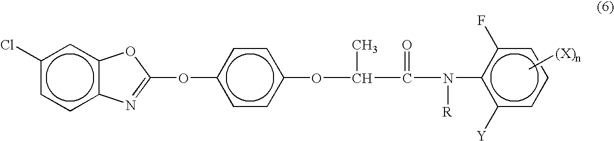

Even though many of herbicides for rice have been recently developed and used, barnyard grass among weeds is the biggest problem in rice paddy.

Development of herbicides to control barnyard grass is an urgent to one who is in the field of agriculture. After transplanting young rice, herbicides, developed until now, cannot effectively control the production of barnyard grass so that it causes a huge damage to harvest. It has been reported that the amount of rice harvest is decreased by 2% when barnyard grass is produced 1 week per 1 m², decreased by about 10% when produced 5 weeks per 1 m², decreased by about 19% when produced 10 weeks per 1 m² and decreased by about 35% when produced 20 weeks per 1 m².

Many different kinds of herbicides have been used for the purpose of controlling barnyard grass that damages in amount of harvest of rice. However, the herbicide with a broader herbicidal activity, environment-friendly property and cost-effectiveness is still in demand.

The inventors have intensively studied to provide herbicides to effectively control barnyard grass, and particularly, to find out selective herbicidal activity of phenoxypropionic acid N-alkyl-N-2-fluorophenyl amide compounds of formula (6). As a result, we completed this invention by finding that some phenoxypropionic acid N-alkyl-N-2-fluorophenyl amides of formula (6) exist as (R)- or (S)-stereoisomer, and (R)-stereoisomers provide higher stability to rice and better herbicidal activity compared to (S)-stereoisomers or mixtures thereof. This superior activity of (R)-stereoisomers is distinguished from the conventional inventions.

Therefore, an object of the present invention is to provide optically active herbicide compounds which exhibit excellent selectivity toward rice and prevent the production of harmful barnyard grass.

### DISCLOSURE OF INVENTION

The present invention is to provide optically active herbicide phenoxypropionic acid N-methyl-N-2-fluorophenyl amides of formula (1) with an excellent herbicidal activity as well as selective and remarkable stability toward rice, 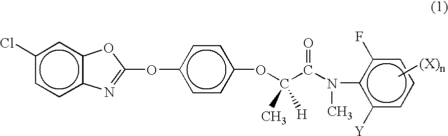
wherein X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; Y is hydrogen or fluoro; and n is an integer of 0 to 2, wherein X can be a combination of other substituents when n is 2.

The optically active compounds of formula (1) according to the present invention may be specified as the following Table 1.

TABLE 1

| | |
|---|---|
| | (1) |
| 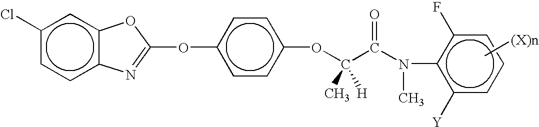 | |

| R | Y | X |
|---|---|---|
| CH₃ | H | H |
| CH₂CH₃ | H | H |
| CH₃ | H | 4-F |
| CH₃ | H | 3-F |
| CH₃ | H | 5-F |
| CH₃ | H | 4-Cl |
| CH₃ | H | 4-F, 5-F |
| CH₃ | H | 4-Br |
| CH₃ | H | 4-CH₃ |
| CH₃ | H | 4-SCH₃ |
| CH₃ | H | 4-CH₂CH₃ |
| CH₃ | H | 4-propyl |
| CH₃ | H | 4-isopropyl |
| CH₃ | H | 4-butyl |
| CH₃ | H | 4-isobutyl |
| CH₃ | H | 4-CO₂CH₃ |
| CH₃ | H | 4-OCH₃ |
| CH₃ | H | 4-OEt |
| CH₃ | H | 4-O-isopropyl |
| CH₃ | H | 4-O-allyl |
| CH₃ | H | 4-O-propyl |
| CH₃ | F | H |
| CH₃ | F | 3-F |
| CH₃ | F | 4-F |
| CH₂CH₃ | F | 4-F |
| CH₃ | F | 4-Cl |
| CH₃ | F | 4-Br |
| CH₃ | F | 4-CH₃ |
| CH₃ | F | 4-CH₂CH₃ |
| CH₃ | F | 4-propyl |
| CH₃ | F | 4-isopropyl |
| CH₃ | F | 4-cyclopropyl |
| CH₃ | F | 4-butyl |
| CH₃ | F | 4-isobutyl |
| CH₃ | F | 4-OCH₃ |
| CH₃ | F | 4-OEt |
| CH₃ | F | 4-O-isopropyl |
| CH₃ | F | 4-O-propyl |
| CH₃ | F | 3-F, 5-F |
| CH₃ | H | 5-F |
| CH₃ | H | 5-Cl |
| CH₃ | H | 5-Br |
| CH₃ | H | 5-CH₃ |
| CH₃ | H | 5-SCH₃ |
| CH₃ | H | 5-CH₂CH₃ |
| CH₃ | H | 5-propyl |
| CH₃ | H | 5-isopropyl |
| CH₃ | H | 5-cyclopropyl |
| CH₃ | H | 5-butyl |
| CH₃ | H | 5-isobutyl |
| CH₃ | H | 5-OCH₃ |
| CH₃ | H | 4-OEt |
| CH₃ | H | 5-O-isopropyl |
| CH₃ | H | 5-O-propyl |
| CH₃ | H | 5-O-allyl |
| CH₃ | F | 5-H |
| CH₃ | F | 5-F |
| CH₃ | F | 5-Cl |
| CH₃ | F | 5-Br |
| CH₃ | F | 5-CH₃ |
| CH₃ | F | 5-CH₂CH₃ |
| CH₃ | F | 5-propyl |
| CH₃ | F | 5-isopropyl |
| CH₃ | F | 5-cyclopropyl |
| CH₃ | F | 5-n-butyl |
| CH₃ | F | 5-isobutyl |
| CH₃ | F | 5-OCH₃ |
| CH₃ | F | 5-OEt |
| CH₃ | F | 5-O-isopropyl |
| CH₃ | F | 5-O-propyl |

The optically active compounds of formula (1) according to this invention may be synthesized by employing a conventional method represented in the following Scheme 1, reacting a compound of formula (7) with a compound of formula (8), 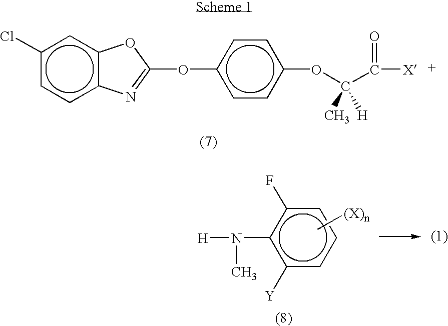
wherein X′ is OH, Cl, Br, or phenoxy; X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; Y is hydrogen or fluoro; and n is an integer of 0 to 2, wherein X can be a combination of other substituents when n is 2.

In the method according to Scheme 1, it is performed preferably to use a binder such as triphenylphosphine and an organic base such as triethylamine or pyridine at a temperature of 0 to 100° C. in an inert solvent such as ethers like tetrahydrofuran, ethyethyl acetate, acetonitrile, toluene, xylene, hexane, methylene chloride, carbon tetrachloride, dichloroethane or the like. After the solvent is evaporated, the crude product is purified by column chromatography.

Another method for preparing the compounds (1) represented in the following Scheme 2 is an alkylation of a compound of formula (9) to a compound of formula (10), 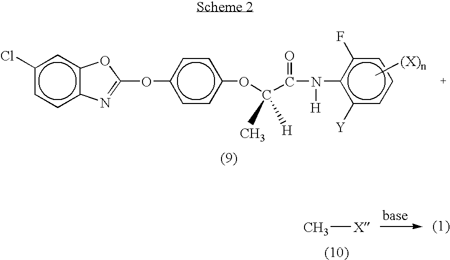
wherein X″ is Cl, Br, I, benzenesulfonyloxy, toluenesulfonyloxy, methanesulfonyloxy or low alkyl sulfate; and X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; Y is hydrogen or fluoro; and n is an integer of 0 to 2, wherein X can be a combination of other substituents when n is 2.

In scheme 2, it is performed preferably using a strong base which is enough to pull out a hydrogen from amide, NH. Examples of a strong base include NaOH, KOH, LiOH, NaH, n-BuLi, LDA, and the like. The reaction is performed at a temperature of −78 to 50° C. in an inert solvent such as ethers like ethylether, dioxane or tetrahydrofuran or hydrocarbons like hexane.

Another method for preparing the compounds (1) represented in the following Scheme 3 is a reaction of a compound of formula (11) with a compound of formula (12) in the presence of a base, 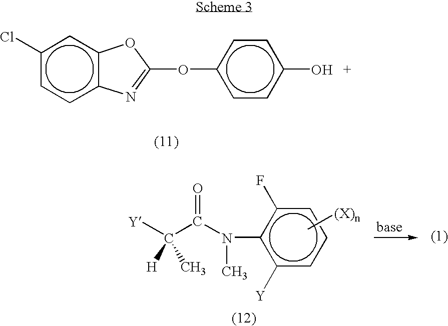
wherein Y′ is halogen, alkylsulfonyloxy, haloalkylsulfonyloxy, benzenesulfonyloxy or toluenesulfonyloxy; X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; Y is hydrogen or fluoro; and n is an integer of 0 to 2, wherein X can be a combination of other substituents when n is 2.

In Scheme 3, examples of the base include inorganic bases of alkali metal hydroxides such as sodium hydroxide and potassium hydroxide, alkali metal carbonates such as sodium carbonate and potassium carbonate, alkali metal hydrogen carbonates such as sodium hydrogencarbonate and potassium hydrogencarbonate; and organic bases such as triethylamine, N,N-dimethylaniline, pyridine and 1,8-diazabicyclo[5,4,0]undec-7-ene.

A phase transition catalyst such as tetra-n-butylammonium bromide or 18-crown-6-[1,4,7,10,13,16-hexaoctacyclooctadecane] may be added to rapidly complete the reaction, if necessary. Further, one or more than two solvents may be used, if deemed necessary. Examples of the inert organic solvent include ketones such as acetone; aromatic hydrocarbons such as toluene, xylene and chlorobenzene; aliphatic hydrocarbons such as petroleum ether and ligroin; ethers such as diethylether, tetrahydrofuran and dioxane; nitrites such as acetonitrile and propionitrile; and amides such as N,N-dimethylformamide, N,N-dimethylacetamide, and N-methylpyrrolidone. A reaction is carried out at a temperature of from 0° C. to reflux, preferably at 5 to 50° C., for 1 to 24 hour(s) to afford the desired product with high yield.

Another method for preparing the optically active compound (1) represented in the following Scheme 4 is a reaction of a compound of formula (13) with a compound of formula (14) in the presence of a base, 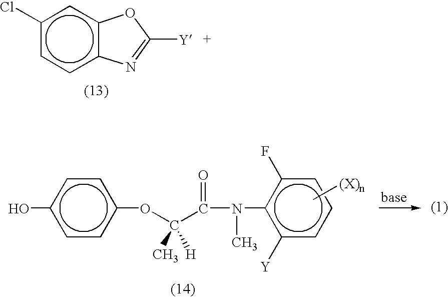
wherein Y′ is halogen, alkylsulfonyloxy, haloalkylsulfonyloxy, benzenesulfonyloxy or toluenesulfonyloxy; X is hydrogen, halogen, hydroxy, NH₂, CO₂H, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthonyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl; Y is hydrogen or fluoro; and n is an integer of 0 to 2, wherein X can be a combination of other substituents when n is 2.

In Scheme 4, examples of the base include inorganic bases of alkali metal hydroxides such as sodium hydroxide and potassium hydroxide, alkali metal carbonates such as sodium carbonate and potassium carbonate, alkali metal hydrogencarbonates such as sodium hydrogencarbonate and potassium hydrogencarbonate; and organic bases such as triethylamine, N,N-dimethylaniline, pyridine, picoline, quinoline, and 1,8-diazabicyclo[5,4,O]undec-7-ene.

A phase transition catalyst such as tetra-n-butylammonium bromide or 18-crown-6[1,4,7,10,13,16-hexaoctacyclooctadecane] may be used, if necessary. Further, more than one solvent may be used if deemed necessary. Examples of the inert organic solvent include ketones such as acetone and butanone; aromatic hydrocarbons such as benzene, toluene, xylene and chlorobenzene; aliphatic hydrocarbons such as petroleum ether, and ligroin; ethers such as diethylether, tetrahydrofuran and dioxane; nitrites such as acetonitrile or propionitrile; and amides such as N,N-dimethylformamide, N,N-dimethyl acetamide and N-methylpyrrolidone. A reaction is carried at a temperature of from 0° C. to reflux, preferably at 20 to 100° C. for 1 to 24 hour(s) to afford the desired product with high yield.

The present invention will be further illustrated by the following examples. However, they should not be construed as limiting the scope of this invention defined by the appended claims.

### EXAMPLES

### Example 1

### Preparation of (S)-2-bromo-propionic acid-N-(2-fluorophenyl)-N-methyl amide

(S)-2-Bromopropionic acid(3.4 g, 0.022 mol) and 2-fluoroaniline(3 g, 0.024 mol) were dissolved in 50 ml of chloroform and cooled to 0° C. Dicyclohexylcarbodiimide(5 g, 0.024 mol) dissolved in 10 ml of chloroform was slowly injected through a syringe. The temperature of the reaction mixture was raised to room temperature and the reaction mixture was stirred for 1 hour. Solid remained during the reaction was filtered out and washed twice with 20 ml of chloroform. The filtrate was concentrated under reduced pressure and the crude product was purified by column chromatography (eluent; ethyl acetate/n-hexane=1/3) to afford 5 g of the target product.

¹H-NMR(CDCl₃): δ1.7(3H, d), 3.24(3H, s), 4.16(0.7H, q), 4.34(0.3H, q), 7.13-7.48(4H, m)

### Example 2

### Preparation of (R)-2-(4-hydroxyphenoxy)propionic acid-N-(2-fluorophenyl)-N-methyl amide

(S)-2-bromo-propionic acid-N-(2-fluorophenyl)-N-methyl amide (18.2 g, 0.07 mol), hydroquinone (7 g, 0.064 mol), potassium carbonate (10.54 g, 0.076 mol) and tetra-n-butylammonium bromide (1 g) were dissolved in 350 ml of acetonitrile and heated at reflux for 6 hours. The reaction mixture was cooled to room temperature and solid remained during the reaction was filtered out. The filtrate was concentrated under reduced pressure and the crude product was purified by column chromatography(eluent: ethyl acetate/n-hexane=1/2) to afford 16 g of the target product.

¹H-NMR(CDCl₃): δ1.42(3H, t), 3.25(3H, s), 4.56(1H, q), 6.5-7.4(8H, m)

### Example 3

### Preparation of (R)-2-[4-(6-chloro-2-benzoxazolyloxy)-phenoxy]propionic acid-N-(2-fluorophenyl)-N-methyl amide

(R)-2-(4-hydroxyphenoxy)propionic acid-N-(2-fluorophenyl)-N-methyl amide (11.5 g, 0.04 mol), 2,6-dichlorobenzoxazole (6.85 g, 0.036 mol), potassium carbonate (6 g, 0.043 mol) and tetra-n-butylammonium bromide (1 g) were dissolved in 300 ml of acetonitrile and heated at reflux for 7 hours. The reaction mixture was cooled to room temperature and solid remained during the reaction was filtered out. The filtrate was concentrated under reduced pressure and the crude product was purified by column chromatography (eluent: ethyl acetate/n-hexane=1/3) to afford 12.5 g of the target product.

¹H-NMR(CDCl₃): δ1.42(3H, t), 3.3(3H, s), 4.62(1H, m), 6.8-7.4(11H, m)

### Example 4

### Preparation of (R)-2-[4-(6-chloro-2-benzoxazolyloxy)-phenoxy]propionic acid-N-(2-fluorophenyl)-N-methyl amide

(R)-2-[4-(6-chloro-2-benzoxazoyloxy)-phenoxy]propionic acid (346.7 mg, 1 mmol) was dissolved in 10 ml of tetrahydrofuran. 2-Fluoroaniline(111.12 mg, 1 mmol), triphenylphosphine(393.4 mg, 1.5 mmol), triethylamine(0.15 ml, 1 mmol) and carbon tetrachloride(1 ml) were added sequentially and heated at reflux for 8 hours. The reaction mixture was cooled to room temperature and acidified with 5% hydrochloric acid, followed by addition of water. The acidified reaction mixture was extracted three times with ethyl acetate. The combined organic layer was dried over magnesium sulfate, filtered and concentrated under reduced pressure. The crude product was purified by column chromatography(eluent: ethyl acetate/n-hexane=1/4) to afford 200 mg of the target product.

m.p: 132-136° C. ¹H-NMR(CDCl₃): δ1.7(3H, d), 4.81(1H, q), 7.05-7.45(10H, m), 8.35(1H, m), 8.5(1H, br)

### Example 5

### Preparation of (R)-2-[4-(6-chloro-2-benzoxazolyloxy)-phenoxy]propionic acid-N-(2-fluorophenyl)-N-methyl Amide

(R)-2-[4-(6-chloro-2-benzoxazoyloxy)-phenoxy]propionic acid-N-(2-fluorophenyl)amide (100 mg, 0.24 mmol) was dissolved in 10 ml of anhydrous tetrahydrofuran and 60% NaH(10 mg, 0.24 mmol) and CH₃I(34 mg, 0.24 mmol) were added sequentially at 0° C. The reaction mixture was stirred at room temperature for 5 hours. Ice water was poured to the reaction mixture and it was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 75 mg of the target product.

¹H-NMR(CDCl₃): δ1.42(3H, t), 3.3(3H, s), 4.62(1H, m), 6.8-7.4(11H, m)

### Example 6

### Preparation of (R)-2-[4(6-chloro-2-benzoxazolyloxy)-phenoxy]propionic acid-N-(2-fluorophenyl)-N-methyl amide

(R)-2-[4-(6-chloro-2-benzoxazoyloxy)-phenoxy]propionic acid(346.7 mg, 1 mmol) was dissolved in 10 ml of tetrahydrofuran and N-methyl-2-fluoroaniline(125 mg, 1 mmol), triphenylphosphine(393.4 mg, 1.5 mmol), triethylamine(0.15 ml, 1 mmol) and carbon tetrachloride(1 ml) were added sequentially and the reaction was heated at reflux for 12 hours. The reaction mixture was cooled to room temperature and acidified with 5% hydrochloric acid, followed by addition of water. The acidified reaction mixture was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 100 mg of the target product.

### Example 7

### Preparation of (R)-2-[4-(6-chloro-2-benzoxazolyloxy-phenoxy)propionic acid-N-methyl-N-(2,4,5-trifluorophenyl)amide

(R)-2-[4-(6-chloro-2-benzoxazoyloxy)-phenoxy]propionic acid (0.693 g, 2 mmol) was dissolved in 15 ml of tetrahydrofuran and N-methyl-2,4,5-trifluoroaniline(0.322 g, 2 mmol), triphenylphosphine(0.78g, 2 mmol), triethylamine(0.4 ml) and carbon tetrachloride(2 ml) were added sequentially and then the reaction mixture was heated at reflux for 18 hours. The reaction mixture was cooled to room temperature and acidified with 5% hydrochloric acid. The acidified reaction mixture was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 250 mg of the target product.

¹H-NMR(CDCl₃): δ1.42(3H, d), 3.2(3H, s), 4.65(1H, m), 6.6-7.4(9H, m)

### Example 8

### Preparation of (R)-2-[4-(6-chloro-2-benzoxazolyloxy)-phenoxy]propionic acid-N-methyl-N-(2,6-difluoro-phenyl)amide

(R)-2-[4-(6-chloro-2-benzoxazoyloxy)-phenoxy]propionic acid(0.693 g, 2 mmol) and N-methyl-2,6-difluoroaniline(0.284 g, 2 mmol) were dissolved in 20 ml of tetrahydrofuran and triphenylphosphine(0.78 g, 2 mmol), triethylamine(0.42 ml) and carbon tetrachloride(2 ml) were added sequentially. The reaction mixture was heated at reflux for 16 hours. The reaction mixture was cooled to room temperature and acidified with 5% hydrochloric acid. The acidified reaction mixture was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 205 mg of the target product.

¹H-NMR(CDCl₃): δ1.4(3H, d), 3.3(3H, s), 4.62(1H, q), 6.8-7.4(10H, m)

### Example 9

### Preparation of (R)-2-[4-(6-chloro-2-benzoxazolyloxy)-phenoxy]propionic acid-N-(2,4-difluorophenyl)-N-methyl amide

(R)-2-[4-(6-chloro-2-benzoxazoyloxy)-phenoxy]propionic acid(0.693 g, 2 mmol) was dissolved in 15 ml of tetrahydrofuran and N-methyl-2,4-difluoroaniline(0.284 g, 2 mmol), triphenylphosphine(0.78 g, 2 mmol), triethylamine(0.42 ml) and carbon tetrachloride(2 ml) were added sequentially. The reaction mixture was heated at reflux for 12 hours. The reaction mixture was cooled to room temperature and acidified with 5% hydrochloric acid, followed by addition of water. The acidified reaction mixture was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 230 mg of the target product.

¹H-NMR(CDCl₃): δ1.4(3H, d), 3.2(3H, s), 4.6(1H, q), 6.6-7.2(10H, m)

### Example 10

### Preparation of (R)-2-[4-(6-chloro-2-benzoxazolyloxy)-phenoxy]propionic acid-N-methyl-N-(2,3,6-trifluorophenyl)amide

(R)-2-[4-(6-chloro-2-benzoxazoyloxy)-phenoxy]propionic acid(0.693g, 2 mmol) was added to 6 ml of thionyl chloride and the reaction mixture was heated at reflux for 2 hours. Excess of thionyl chloride was removed under reduced pressure and 3 ml of anhydrous tetrahydrofuran was added to it. A solution of N-methyl-2,3,6-trifluoroaniline(0.32 g, 2 mmol) and triethyl amine(0.42 ml) in anhydrous tetrahydrofuran(10 ml) was added slowly to the reaction mixture at 0° C. The mixture was stirred at 0° C. for 30 minutes and stirred at room temperature for additional 1 hour. After pouring water the reaction mixture was extracted three times with ethyl acetate. The combined organic solvent layer was dried over magnesium sulfate, filtered and concentrated under reduced pressure. The crude product was purified by column chromatography(eluent: ethyl acetate/n-hexane=1/2) to afford 240 mg of the target product.

¹H-NMR(CDCl₃): δ1.45(3H, d), 3.25(3H, s), 4.6(1H, q), 6.7-7.4(9H, m)

### Examples 11-16

The compounds represented in the following Table 2 were prepared by the same procedure of example 10 except using of aniline compounds instead of N-methyl-2,3,6-trifluoroaniline.

TABLE 2

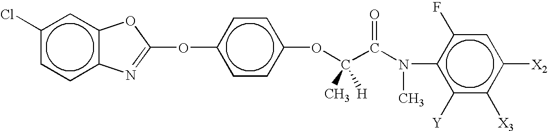

| Classification | X₁ | X₂ | ¹H-NMR(CDCl₃) |
|---|---|---|---|
| Example 11 | H | CH₃ | 1.42(3H, t), 2.3(3H, s), 3.25(3H, s), 4.62(1H, m), 6.8- |
| | | | 7.4(10H, m) |
| Example 12 | Cl | H | 1.42(3H, t), 3.3(3H, s), 4.62(1H, m), 6.7-7.5(10H, m) |
| Example 13 | H | F | 1.42(3H, t), 3.3(3H, s), 4.62(1H, m), 6.5-7.4(10H, m) |
| Example 14 | CH₃ | H | 1.42(3H, t), 2.38(3H, s), 3.25(3H, s), 4.62(1H, m), 6.8- |
| | | | 7.4(10H, m) |
| Example 15 | OCH₃ | H | 1.42(3H, t), 3.25(3H, s), 3.8(3H, s), 4.65(1H, m), 6.65- |
| | | | 7.45(10H, m) |
| Example 16 | OCH₂CH₃ | H | 1.25(3H, t), 1.42(3H, t), 3.25(3H, s), 4.0(2H, q), |
| | | | 4.62(1H, m), 6.65-7.42(10H. m) |

Formulation

In order to use the compounds according to the present invention as herbicides, they should be formulated in such a suitable type such as wettable powder, emulsions, granules, dusts, suspensions and solutions by combining a carrier, a surfactant, a dispersing agent or a supplement agent. Many of these may be applied directly or after diluted with suitable media. Formulations can be prepared at spray volume of from hundreds liters to thousands liters per hectare. The formulations contain about 0.1% to 99% by weight of active ingredient(s) and 0.1% to 20% surfactant(s) or 0% to 99.9% solid or liquid diluent(s) are recommended to be added. The formulations will contain these ingredients in the following approximate proportions shown in Table 3.

TABLE 3

| | Wt. % | | |
|---|---|---|---|
| Formulations | Active ingredient | Diluent | Surfactant |
| Wettable powder | 10-90 | 0-74 | 1-10 |
| Suspension | 3-50 | 40-95 | 0-15 |
| Emulsion . solution | 3-50 | 40-95 | 0-15 |
| Granule | 0.1-95 | 5-99.9 | 1-15 |

The proportion of active ingredients depends on the intended use. Higher ratio of a surfactant is sometimes desired to active ingredients and is achieved by incorporation into the formulation or tank mixing.

Solid diluents with high absorption are preferred for wettable powder. Liquid diluents and solvents are preferred to be stable against phase separation at 0° C. All the formulations may contain a small amount of additives to prevent forming, caking, corrosion and growth of microorganisms.

According to conventional methods to prepare the composition, solutions can be made only by blending ingredients and fine solids by blending and pulverizing with hammer-mill. Suspensions can be made by wet-milling and granules can be made by spraying the active ingredients on performed granular carrier.

Preparation examples of typical formulations are as follows.

Formulation 1: Wettable Powder

The ingredients are thoroughly blended, re-blended after spraying liquid surfactant on the solid ingredients and hammer-milled until all the solids are essentially under 100 μm.

| | |
|---|---|
| Active ingredient (Compound of Example 3) | 20 wt. % |
| Dodecylphenol polyethylene glycol ether | 2 wt. % |
| Sodium ligninsulfonate | 4 wt. % |
| Sodium silicon aluminate | 6 wt. % |
| Montmorillonite | 68 wt. % |

Formulation 2: Wettable Powder

The ingredients are blended, hammer-milled until all the solids are under 25 μm and packaged.

| | |
|---|---|
| Active ingredient (Compound of Example 3) | 80 wt. % |
| Sodium alkyl naphthalenesulfonate | 2 wt. % |
| Sodium ligninsulfonate | 2 wt. % |
| Synthetic amorphous silica | 3 wt. % |
| Kaolinite | 13 wt. % |

Formulation 3: Emulsion

The ingredients are mixed and homogeneously dissolved to give emulsions.

| | |
|---|---|
| Active ingredient (Compound of Example 3) | 30 wt. % |
| Cyclohexanone | 20 wt. % |
| Polyoxyethylene alkylaryl ether | 11 wt. % |
| Calcium alkylbenzenesulfonate | 4 wt. % |
| Methylnaphthalene | 35 wt. % |

Formulation 4: Granule

The ingredients were thoroughly blended. 20 parts by weight of water was added to 100 parts of weight the ingredient mixture. The ingredient mixture was granulated with a size of 14 to 32 mesh by using extrusive granulator and dried.

| | |
|---|---|
| Active ingredient (Compound of Example 3) | 5 wt. % |
| Sodium laurylalcoholsulfonate | 2 wt. % |
| Sodium ligninsulfonate | 5 wt. % |
| Carboxymethyl cellulose | 2 wt. % |
| Potassium sulfate | 16 wt. % |
| Plaster | 70 wt. % |

The formulations according to this invention were sprayed with diluting to a certain concentration.

Utility

The compounds according to the present invention represent high activity as leaf treatment herbicides for rice and especially effective in rice due to an excellent control of barnyard grass.

The active ingredients can be used from 10 g to 4 kg per hectare, preferably from 50 g to 400 g. The amount of the compounds of the present invention depends on the amount and size of weeds and formulations. The herbicides of the present invention can be used as alone or in combination with other herbicides, insecticides or bactericides. Especially it is essential to add one agent selected from the group consisting of bentazon, quinclorac, propanil, simetryn, 2,4-D, fenoxaprop-ethyl, linuron, MCPA, azafenidin, carfentrazone, molinate, thiobencarb, pendimethalin, bensulfuron-methyl, pyrazosulfuron-ethyl, metsulfuron-methyl, thifensulfuron-methyl, tribenuron-methyl, trifluralin, amidosulfuron, bromoxynil, butachlor, mecoprop, metribuzin, bifenox, benfuresate, isoproturon, cyhalofop-butyl, mefenaset, fentrazamide, pyriminobac-methyl, bispyribac sodium, azimsulfruon, cyclosulfamuron, pyanchor, and mixtures thereof.

The herbicidal effect of the compounds of this invention was tested and the examples are as follows.

Experimental Example 1: Leaf Treatment Test

Seeds of rice, wheat, barley, corn, cotton, barnyard grass, common sorgum, large crabgrass and fall panicum were seeded at a pot with a surface area of 600 cm². When barnyard grass grown in a green house kept at 20-30° C. had three leaves, wettable powder prepared by mixing 1 part by weight of the active compound, 5 parts by weight of acetone and 1 part by weight of emulsifier and diluted with water was applied directly to the leaves in 2000 L per hectare. The concentration of the spray liquid was so chosen the particular amounts of the active compound desired. 14 days after the treatment, the degree of damage to the plants was rated in % damage in comparison to the development of untreated control.

| | |
|---|---|
| 0% | no effect (same as untreated control) |
| 20% | slight effect |
| 70% | herbicidal effect |
| 100% | total destruction |

In the test, the active compound(s) of formula (1) according to the invention exhibited an excellent selectivity toward the plants and herbicidal activity against weeds.

TABLE 4

| Abbr. | Scientific Name | English Name |
|---|---|---|
| ORYSA | Oryza sativa L. cv. Dongjin | Rice |
| ECHCG | Echinochloa crus-galli Beauv. var. caudata | Barnyard grass |
| | Kitagawa | |

Among the compounds of formula (1), herbicidal activity of (R)-2-[4-chloro-2-benzoxazoyloxy]-phenoxy]propionic acid-N-(2-flurorophenyl)-N-methyl amide (Example 3) was compared to the (S)-stereoisomer and racemic mixture thereof and the result is summarized in table 5.

TABLE 5

| | | | R,S-racemic | | | |
|---|---|---|---|---|---|---|
| Amount | (R)-compound | | compound | | (S)-compound | |
| of Leaf | | Barn- | | Barn- | | Barn- |
| treat- | | yard | | yard | | yard |
| ment | Rice (4 | grass (4 | Rice (4 | grass (4 | Rice (4 | grass (4 |
| (g/ha) | leaves) | leaves) | leaves) | leaves) | leaves) | leaves) |
| 4000 | 22.5 | 100 | 3.8 | 100 | 0.0 | 100 |
| 2000 | 11.3 | 100 | 0.0 | 100 | 0.0 | 100 |
| 1000 | 2.5 | 100 | 0.0 | 100 | 0.0 | 100 |
| 500 | 0.0 | 100 | 0.0 | 100 | 0.0 | 100 |
| 250 | 0.0 | 100 | 0.0 | 100 | 0.0 | 100 |
| 125 | 0.0 | 100 | 0.0 | 100 | 0.0 | 100 |
| 63 | 0.0 | 100 | 0.0 | 100 | 0.0 | 100 |
| 32 | 0.0 | 100 | 0.0 | 100 | 0.0 | 92.5 |
| 16 | 0.0 | 100 | 0.0 | 100 | 0.0 | 65.0 |
| 8 | 0.0 | 98.8 | 0.0 | 45.0 | 0.0 | 7.5 |
| 4 | 0.0 | 62.5 | 0.0 | 2.5 | 0.0 | 0.0 |
| 2 | 0.0 | 6.3 | 0.0 | 0.0 | 0.0 | 0.0 |
| 1 | — | — | — | — | — | — |

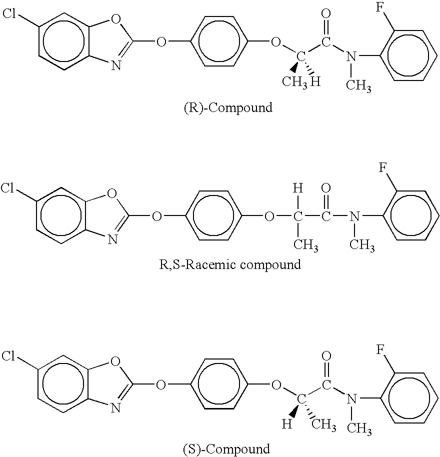

### INDUSTRIAL APPLICABILITY

As described above, it is noted that optically active (R)-stereoisomers of the present invention exhibit excellent selectivity toward rice and superior herbicidal activity against barnyard grass to racemic mixtures and (S)-stereoisomers thereof. Therefore, the optically active compounds of the present invention may be very effective in rice farming. Further, it is proved that the optically active compounds are very stable for wheat, barley, beans, and corn and useful to control weeds.

1. A herbicidal compound, (R)-phenoxypropionic acid-N-methyl-N-2-fluorophenyl amide of formula (1), having stability toward rice and preventing the generation of barnyard grass: 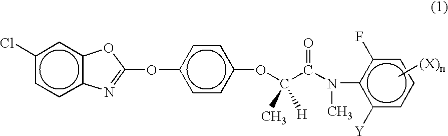
wherein X is hydrogen, halogen, hydroxy, NH₂, CO₂H, CN, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthionyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

2. The herbicidal compound according to claim 1, wherein said X is H, F, Cl, Br, CN, CH₃, or OCH₃; Y is H or F; and n=1.

3. The herbicidal compound according to claim 1, wherein said X is H; and Y is H.

4. The herbicidal compound according to claim 1, wherein said X is 5-CH₃; and Y is H.

5. The herbicidal compound according to claim 1, wherein said X is 4,5-F₂; and Y is H.

6. A method of controlling barnyard grass produced while growing rice without inflicting any substantial harm to said rice which comprises applying an effective amount of at least one compound of formula (1): 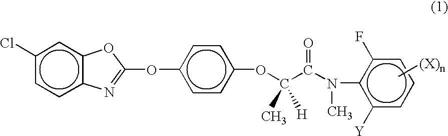
wherein X is hydrogen, halogen, hydroxy, NH₂, CO₂H, CN, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthionyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

7. A herbicidal composition comprising at least one compound of formula (1) together with at least one member selected from the group consisting of: an agriculturally acceptable carrier, a supplement agent, a surfactant and at least one other herbicidal compound: 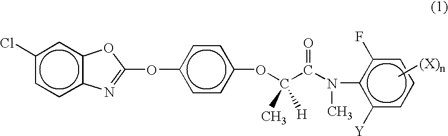
wherein X is hydrogen, halogen, hydroxy, NH₂, CO₂H, CN, C₁-C₆ alkylamino substituted with 1 or 2 of C₁-C₃ alkyl, C₁-C₆ alkyl, C₁-C₆ alkoxy, C₁-C₃ haloalkyl, C₁-C₃ haloalkoxy, C₂-C₄ alkoxyalkoxy, C₁-C₄ alkylthionyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

8. A herbicidal compound, (R)-phenoxypropionic acid-N-methyl-N-2-fluorophenyl amide of formula (1), having stability toward rice and preventing the generation of barnyard grass: 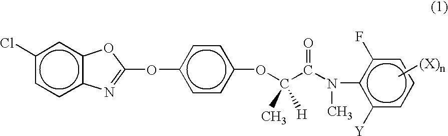
wherein X is hydroxy, NH₂, CO₂H, CN, C₁-C₆ alkylamino substituted with 1 or 2 of C₁-C₃ alkyl, C₂-C₄ alkoxyalkoxy, C₁-C₄ alkylthionyl, C₁-₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

9. A herbicidal compound, (R)-phenoxypropionic acid-N-methyl-N-2-fluorophenyl amide of formula (1), having stability toward rice and preventing the generation of barnyard grass: 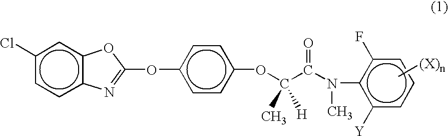
wherein X is hydroxy, NH₂, CO₂H, CN, C₁-C₆ alkylamino substituted with 1 or 2 of C₁-C₃ alkyl, C₁-C₄ alkylthionyl, C₁-C₄ alkylsulfonyl, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

10. A method of controlling barnyard grass produced while growing rice without inflicting any substantial harm to said rice which comprises applying an effective amount of at least one compound of formula (1): 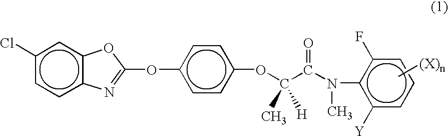
wherein X is hydroxy, NH₂, CO₂H, CN, C₁-C₆ alkylamino substituted with 1 or 2 of C₁-C₃ alkyl, C₂-C₄ alkoxyalkoxy, C₁-C₄ alkylthionyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

11. A method of controlling barnyard grass produced while growing rice without inflicting any substantial harm to said rice which comprises applying an effective amount of at least one compound of formula (1): 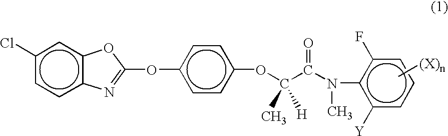
wherein X hydroxy, NH₂, CO₂H, CN, C₁-C₆ alkylamino substituted with 1 or 2 of C₁-C₃ alkyl, C₁-C₄ alkylthionyl, C₁-C₄ alkylsulfonyl, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

12. A herbicidal composition comprising at least one compound of formula (1) together with at least one member selected from the group consisting of: an agriculturally acceptable carrier, a supplement agent, a surfactant and at least one other herbicidal compound: 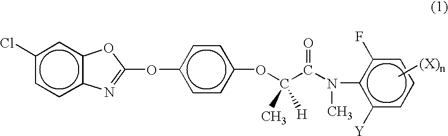
wherein X is hydroxy, NH₂, CO₂H, CN, C₁-C₆ alkylamino substituted with 1 or 2 of C₁-C₃ alkyl, C₂-C₄ alkoxyalkoxy, C₁-C₄ alkylthionyl, C₁-C₄ alkylsulfonyl, C₂-C₆ alkenyl, C₂-C₆ alkinyl, C₂-C₆ alkenyloxy, C₂-C₆ alkinyloxy, C₁-C₃ alkoxycarbonyl, or C₁-C₃ alkylcarbonyl;
Y is hydrogen or fluoro; and
n is an integer of 0 to 2, wherein X can be a combination of other substituents when n is 2.

13. A herbicidal composition comprising at least one compound of formula (1) together with at least one member selected from the group consisting of: an agriculturally acceptable carrier, a supplement agent, a surfactant and at least one other herbicidal compound: 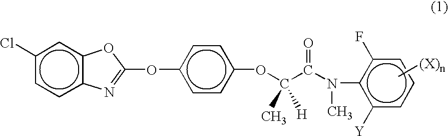
wherein X is hydroxy, NH₂, CO₂H, CN, C₁-C₆ alkylamino substituted with 1 or 2 of C₁-C₃ alkyl, C₁-C₄ alkylthionyl, C₁-C₄ alkylsulfonyl, C₁-C₃ alkoxycarbonyl, or C₁-C₃ alkylcarbonyl;
Y is hydrogen or fluoro; and
n is an integer of 0 to 2, wherein X can be a combination of other substituents when n is 2.
